(19) United States
(12) Patent Application Publication
(10) Pub. No.: US 2015/0239349 A1
(43) Pub. Date: Aug. 27, 2015

(54) NON-RAIL-BOUND VEHICLE WITH IMPROVED CURRENT COLLECTOR

(71) Applicant: SIEMENS AKTIENGESELLSCHAFT, München (DE)

(72) Inventor: Goeran Keil, Berlin (DE)

(21) Appl. No.: 14/432,250

(22) PCT Filed: Sep. 12, 2013
(86) PCT No.: PCT/EP2013/068894

§ 371 Date: Mar. 30, 2015

(30) Foreign Application Priority Data
Sep. 28, 2012 (DE) 10 2012 217 720.5

(51) Int. Cl. B60L 5/08; B60L 5/36

(52) U.S. Cl. CPC B60L 5/08; B60L 5/36; B60L 2200/18; B60L 2200/36

(57) ABSTRACT

A non-rail-bound vehicle, in particular a truck or a bus, has a current collector for supplying electric energy from a two-pole overhead conductor with contact wires forming feed and return conductors. The wires are contacted by contact strips of the current collector. The current collector has a linkage that supports a rocker arrangement on the contact-wire side. The rocker arrangement has the contact strips, and is coupled to an adjusting device on the vehicle side for carrying out an adjusting movement of the rocker arrangement relative to the vehicle, transversely to a vehicle longitudinal axis. A vibration damper is configured to damp an intrinsic rocker arrangement vibration which can be stimulated in the adjusting movement direction. The current collector of the vehicle can thus be laterally adjusted in a short adjusting time in the event of steering imprecisions in order to ensure reliable contact with the overhead conductor.

The invention relates to a non-rail-bound vehicle according to the preamble of claim 1.

It has long been known for rail-bound vehicles, such as electric locomotives, trains and trams for example, to be fitted with current collectors for the traction supply, which in order to supply electrical energy to the vehicle slide along a contact wire of an overhead contact line system. Thanks to the track guidance of the rails a defined relative position between the at least one contact wire and the rail vehicle can be adhered to, which in normal operation enables a sliding contact to be reliably maintained between current collector and contact wire. Much less common is the external energy infeed to electrically operated vehicles which are not rail-bound.

Thus for example from patent specification DE 32 44 945 C1 a two-pole overhead conductor system for electrically driven public transportation vehicles is known. Of the two overhead conductor wires running in parallel, one conducts voltage to ground and the other acts as a neutral conductor. A trolleybus is equipped with a pair of trolley booms to enable it to run in the overhead conductor system. In operation the pair of trolley booms adopts a position prestressed in respect of the horizontal, in which their contact shoes duly lie on the two overhead conductor wires. The trolley booms are under the force of an uprighting spring which ensures the necessary contact pressure of the contact shoes onto the overhead conductor wires. The trolley booms are hinged on the roof of the trolleybus about a horizontal axis running transversally to the direction of travel, to enable them to be lowered and raised again. To compensate for lateral deviations in travel relative to the course of the overhead conductor wires the trolley booms can also be rotated about a vertical axis, to enable the sliding contact to be held on the overhead conductor wires. However, trolleybuses are lane-bound vehicles, since sudden evasive maneuvers or overtaking maneuvers that cause the vehicle to leave the traffic lane result in a loss of contact between the trolley booms and the overhead conductor wires.

The unexamined German application DE 102 56 705 A1 discloses a non-rail-bound vehicle, used as a truck in mining for transporting ore, coal or spoil. Two pantographs are provided to supply power to an electric motor of the vehicle, and in operation are in contact with contact wires of a two-pole overhead conductor by way of contact strips. So that the vehicle is only ever steered such that the contact strips do not leave the contact wires, sensor strips bearing magnetic field sensors are arranged on the pantographs. These determine the magnetic field strength of the magnetic field generated by the current in the contact wire so precisely that the distance between the sensor and the contact wire can be determined from the measured field strength value. The information about the position of the sensor relative to the contact wire and therefore about the position of the pantograph and therefore of the whole vehicle to the contact wire can be notified to the driver of the vehicle by means of a display unit, so that the driver can immediately execute appropriate steering movements. It is also possible to feed the information from the sensors to a control unit to enable the vehicle to be steered automatically.

A disadvantage of the trolley booms known from trolleybuses is that it is relatively difficult to wire and unwire vehicles and that jerky steering movements may result in the booms becoming derailed, in other words in a loss of contact between the contact shoes and the overhead conductor wires. Thus this system is unsuitable for roadways which at least in places have an electrified lane, parallel to which non-electrified lanes run, for example on multilane freeways. Finally trolley booms are also unsafe at relatively high travel speeds of 80 to 100 km/h, at which commercial vehicles may travel on freeways.

The solutions known from mining vehicles with one current collector per contact wire have the disadvantage that relatively large lateral vehicle movements of over 0.4 m may result in a loss of contact with the overhead conductor. To prevent such losses of contact, the current collector arrangement can also be designed to be wider than the vehicle, but this is dangerous on public roads outside a mining area and is not permitted under road traffic regulations.

The object of the invention is hence to provide a generic vehicle whose current collector can be safely wired and unwired during operation on multilane roadways, at least sections of which are electrified, even when traveling at relatively high speeds of for example 80 to 100 km/h and in this case can reliably maintain contact with the contact wire.

The invention achieves the object by means of a generic vehicle with the features specified in the characterizing part of claim 1. Accordingly the current collector has a linkage which on the contact wire side carries a rocker arrangement comprising the contact strips and on the vehicle side is coupled to an adjusting device for carrying out an adjusting movement of the rocker arrangement relative to the vehicle, said movement being oriented transversally to a vehicle longitudinal axis. As a result imprecisions in the traffic lane can be balanced out in the steering behavior of the vehicle driver by adjusting the current collector, and the contact strips of the current collector can be reliably held in sliding contact with the contact wires. To this end the relative position of the vehicle or current collector to the contact wires is detected, preferably by onboard and more preferably by current-collector-side sensors, such as optical or inductive sensors, and is fed to a control device of the adjusting device for determination of a manipulated variable. According to the invention a vibration damper is arranged in the region of the rocker arrangement, and is designed to damp an intrinsic vibration of the rocker arrangement which can be stimulated in the adjusting movement direction. Intrinsic vibrations of the rocker arrangement result from the geometry of the longitudinally extended linkage with its resiliences and from the distribution of the relatively high mass of the rocker arrangement on the driveless load end of the linkage. The torque of the actuator engages at the driven force end of the linkage in order to execute the adjusting movement to adjust the current collector as quickly as possible, it being possible to stimulate the rocker arrangement to vibrations. According to the invention a stimulation of intrinsic vibrations is damped by vibration dampers, which means an undesired resonance phenomenon is suppressed. Thanks to this measure it is possible to dispense with reinforcing the design of the current collector or actuator to damp intrinsic vibrations and as a result in turn advantageously to obviate the need for excess overall weight of current collector and adjusting device. By suppressing resonance vibrations of the rocker arrangement an associated shifting of the phase angle between exciting actuator and vibrating rocker arrangement is prevented, as a result of which there is advantageously no interference feedback to the torque control of the actuator. Overall the lateral adjustment of the current collector can be converted in a brief adjustment time by a powerful actuator, to ensure that contact is reliably maintained between contact strips and contact wires while the vehicle is in operation.

In an advantageous embodiment of the inventive vehicle the rocker arrangement is rotatably mounted on a cross-bar of the linkage about an axis of rotation running horizontally and transversally to the vehicle longitudinal axis, the vibration damper being attached to the cross-bar. The horizontal vibration of the rocker arrangement transversally to the longitudinal axis of the vehicle experiences the greatest energy input thanks to the actuator. By arranging the vibration damper on the cross-bar the latter's line of action is approximately the same distance from the base point of the vibration as the center of mass of the rocker arrangement.

For example, if two vibration dampers are arranged symmetrically to the longitudinal planes of the vehicle, the damping effect is particularly effective.

In a preferred configuration of the inventive vehicle, the vibration damper has a weight which is arranged so as to be displaced along a guide rod, a spring arrangement coupled to the weight for generating a spring-loaded restoring force when the weight is displaced from its position of equilibrium, and a friction member coupled to the weight for generating a friction force when the weight is displaced. Thanks to this arrangement the weight is coupled to the rocker arrangement in a spring-loaded manner, the weight following the vibration movement of the rocker arrangement with a certain delay. The kinetic energy of the weight is in this case converted by its coupling to the friction member into thermal energy and is thus removed from the rocker arrangement. Here the mass of the weight and the spring constant of the spring arrangement must be adapted to the mass to be damped of the rocker arrangement and its intrinsic frequency to be damped. A further configuration variable represents the damping constant of the friction member. The specific dimensioning of these configuration variables depends on the actual circumstances of the vehicle and its current collector and is known per se to the person skilled in the art.

Preferably the vibration damper of an inventive vehicle has a tubular housing, in which the guide rod is arranged, the weight having a through-hole for the guide rod, and the spring arrangement being formed by two screw springs which are coupled to the weight and attached to an end face of the housing in each case. This means that a defined guided movement of the weight is achieved. In addition the vibration damper can be simply attached by way of the housing to the cross-bar of the rocker arrangement. Furthermore, the housing provides protective encapsulation against environmental conditions.

Further advantages and properties emerge from the following description of an exemplary embodiment of an inventive vehicle on the basis of the drawings, in which

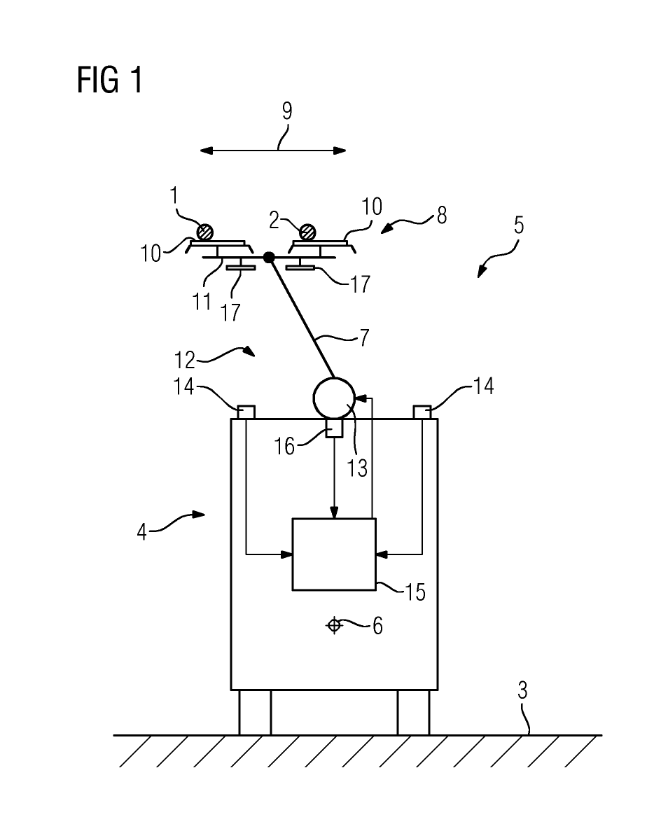

FIG. 1 schematically illustrates an inventive vehicle in the direction of the vehicle longitudinal axis and

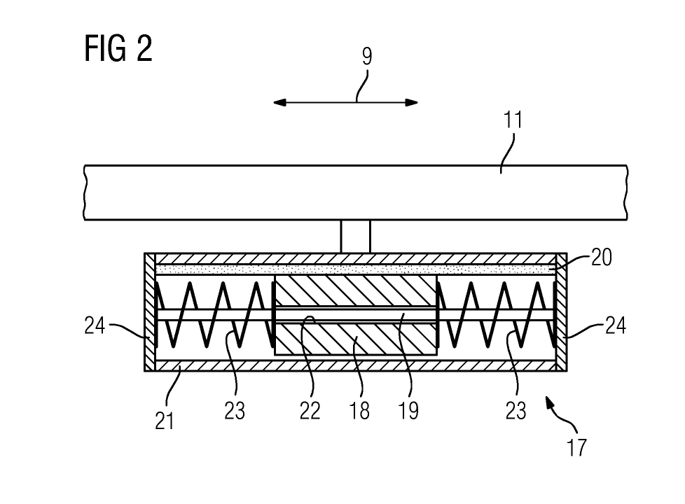

FIG. 2 schematically illustrates a vibration damper associated with the current collector of the vehicle from FIG. 1.

According to FIG. 1 a two-pole overhead contact line system is provided, with a feed conductor 1 and a return conductor 2 running parallel thereto for the electrification of a traffic lane 3. The feed and return conductors 1 and 2 of the overhead contact line system are also designated below as contact wires 1 and 2. They are arranged approximately centrally above the lane 3 by means of infrastructure facilities (not illustrated) such as masts, cantilevers, side arms, messenger wires, hangers, etc. The traffic lane 3 can for example be the right-hand lane of a multilane freeway. This means it is possible to feed electrical energy to a non-rail-bound vehicle 4 with a current collector 5, in order to supply traction energy to an electric or dielectric traction drive of the vehicle 4 or in order to dissipate braking energy of the vehicle 4 to the overhead contact line system.

The current collector 5 is, in respect of a longitudinal axis 6 of the vehicle 4, arranged behind a driver's cab and in front of a loading structure, which are not shown in detail. The current collector 5 has a longitudinally extended linkage 7 which is hinged to the vehicle 4 at its bottom end and carries a rocker arrangement 8 at its top ends. The linkage 7 is represented only schematically in FIG. 1 by a connecting line and can in reality have several transoms or else actuating cylinders for telescopic alteration in length, depending on the configuration. In each case the linkage 7 can however be pivoted such that the rocker arrangement 8 can execute an adjusting movement 9 oriented horizontally and transversally to the vehicle longitudinal axis 6, in order to hold contact strips 10 of the rocker arrangement 8 in sliding contact with the contact wires 1 and 2 in the event of imprecisions in the steering of the vehicle 4.

The rocker arrangement 8 is connected to the linkage 7 by way of a cross-bar 11 which is arranged horizontally and transversally to the vehicle longitudinal axis 6 and defines an axis of rotation for the rocking movement of the rocker arrangement 8. The rocker arrangement 8 comprises two rocker switches, to which contact pieces are attached, each rocker switch having two contact strips 10 arranged in the direction of travel behind one another and mounted using suspension means, and having downward-sloping pantograph horns arranged on their lateral ends. Each pair of contact strips 10 arranged behind one another slides along one of the contact wires 1 or 2.

The adjusting movement 9 of the rocker arrangement 8 is generated by an onboard adjusting device 12 which has an actuator 13 with a gear unit (not shown) and is attached to the vehicle 4. This adjusting movement 9 can be transmitted to the linkage 7 by way of coupling joints (not shown). The manipulated variable for the adjusting movement 9 is predefined by a control system, with sensor means 14 for detecting the position of the vehicle 4 relative to the overhead conductor wires 1 and 2 and a control facility 15 connected to the sensor means 14 and the actuator 13.

The sensor means 14 can for example be formed by a video camera with image evaluation. In the exemplary embodiment illustrated the sensor means 14 however comprise two measuring devices for measuring a magnetic field strength of the magnetic field generated by the contact wires 1 and 2 at the location of the measuring devices. The magnetic field is for example generated by the current flowing for the traction supply in the contact wires 1 and 2. If the vehicle 4 travels centrally below the contact wires 1 and 2, both measuring devices measure the same magnetic field strengths H. If the vehicle 4 travels off-center, the magnetic field strength measured by one measuring device increases, whereas that of the other one drops and vice versa. Thus the position of the vehicle 4 relative to the overhead contact line system can be detected.

Coupled to the actuator 13 is a measuring facility 16 for determining a current rocker deflection, for example the present lateral deflection of the linkage 7 from a neutral position, which in turn corresponds to a unique contact strip position relative to the vehicle 4. The information about the rocker deflection and/or the vehicle position is continuously fed to the control facility 15. The control facility 15 now controls the actuator 13 such that as a function of the vehicle position detected by the sensor means 14 the contact strips 10 keep the contact to the contact wires 1 and 2 inside their operating range b. The control facility 15 thus determines in what way the rocker arrangement 8 has to be pivoted laterally so that the contact strips 10 slide along the contact wires 1 and 2 in their operating range b. However, such control actions may also be necessary in evasive or overtaking maneuvers in the event of driving imprecisions. They may also be necessary if the contact wires 1 and 2 do not run centrally above the traffic lane 3, as is the case for example when the roadway curves.

During execution of the adjusting movement the actuator 13 effects an input of energy into the current collector 5, which stimulates the longitudinally extended linkage 7 and the rocker arrangement 8 hinged thereto to vibrate in particular in the adjusting movement direction 9. Specific attention should be paid here if vibrations with an intrinsic frequency of the rocker arrangement 8 are forced. To prevent feedback such as this to the actuator 13 designed as a servo motor and to the control facility 15, two vibration dampers 17 are arranged symmetrically on the cross-bar 11. The vibration dampers 17 are designed such that an intrinsic vibration of the rocker arrangement 8 which can be stimulated in the adjusting movement direction 9 is damped.

This means an adjusting movement with a short adjusting time is implemented, in order to ensure that the contacts are held securely between current collector 5 and contact wires 1 and 2.

According to FIG. 2 each of the vibration dampers 17 connected to the cross-bar 11 has a cylindrical weight 18 which is penetrated axially by a through-hole 22. The through-hole 22 is used to accommodate a guide rod 19, along which the weight 18 can be displaced. To protect against environmental conditions the weight 18 and the guide rod 19 are arranged in a cylindrical housing 21, to which the vibration damper 17 is attached by way of connection means on the cross-bar 11, such that the weight 18 can be displaced in the adjusting movement direction 9. The housing 21 is closed at its end housing faces 24. The weight 18 is coupled to a spring arrangement to generate a spring-loaded restoring force when the weight 18 is displaced from its position of equilibrium. The spring arrangement has two screw springs 23 which are arranged both sides of the weight 18 and which rest respectively on the weight 18 and on a housing end 24. Furthermore, a friction member 20 is arranged in the housing 21 and is coupled to the weight 18 such that its displacement movement must overcome a friction force.

If now during operation of the vehicle 4, for example during execution of an adjusting movement by a transmission of torque from the actuator 13 to the rocker arrangement 8, an intrinsic vibration of the rocker arrangement 8 is stimulated, the vibration dampers 17 are activated. Thanks to a selective design of the mass of the weight 18 compared to the mass of the vibrating rocker arrangement 8 and of the spring constants of the screw springs 23 and of the friction value of the friction element 20 these damp the forced intrinsic vibration and prevent the current collectors 5 from starting resonance vibration. The weights 18 here follow the vibration movement of the rocker arrangement 8 on a phase-shifted basis. During the displacing movement of the weight 18 along the friction member 20, vibration energy is converted into thermal energy, resulting in a damping of the excitation vibration.

Vibration is in the transversal direction or direction of travel. Expressed in clearer terms, this relates in fact to a rotary vibration about the base point of the current collector with a vibration plane more or less parallel to the roadway. This can however be approximated arithmetically to a linear vibration. In the specific exemplary embodiment it has a resonant frequency of approximately 4.9 Hz. All sorts of other types of vibration are of course also stimulated, but only this one experiences the highest energy input, because the current collector must be moved quickly here and so possesses a powerful electric drive.

The use of the vibration damper 17 at the load end of the linkage 7 brings about a clear reduction in the resonant amplitude and as a result less of a feedback effect of vibrations to the controlled actuator 13. Thus in comparison to current collectors without vibration dampers 17 in actuators 13 with comparable drive torques, it is possible to reduce the reset time of the current collector 5. Besides effective vibration damping the vibration dampers 17 have a small installed size and a low mass. As a ratio of the masses of the weights 18 to those of the current collector 5, a figure of approximately 0.04 is chosen. The spring constants of the screw springs 23 must be designed such that at this mass ratio the intrinsic frequency of the vibration system of the weight/spring arrangement corresponds to the intrinsic frequency to be damped of the current collector 5.

Thanks to the inventive solution a current collector 5 can be constructed for a non-rail-bound vehicle 4 which corresponds to the requirements for speed of response of its drive controller and at the same time minimizes the overall costs.

1-4. (canceled)

5. A non-rail-bound vehicle, comprising:
a current collector for feeding electrical energy from a two-pole overhead contact line having contact wires respectively forming feed and return conductors;
said current collector having a linkage carrying a rocker arrangement on a contact wire side, said rocker arrangement carrying contact strips for contacting the contact wires of the overhead contact line, and said linkage being coupled on a vehicle side to an adjusting device configured for execution of an adjusting movement of the rocker arrangement relative to the vehicle in a direction transversely to a vehicle longitudinal axis; and
a vibration damper disposed at said rocker arrangement and configured for damping an intrinsic vibration of said rocker arrangement that may be stimulated in an adjusting movement direction thereof.

6. The vehicle according to claim 5 being a truck or a bus carrying said current collector.

7. The vehicle according to claim 5, wherein said linkage comprises a cross-bar and said rocker arrangement is mounted on said cross-bar so as to rotate about an axis of rotation that runs horizontally and transversely to the vehicle longitudinal axis, and wherein said vibration damper is attached to said cross-bar.

8. The vehicle according to claim 5, wherein said vibration damper comprises a weight displaceably mounted along a guide rod, a spring configuration coupled to said weight for generating a spring-loaded restoring force when said weight is displaced from a position of equilibrium, and a friction member coupled to said weight for generating a friction force when said weight is displaced.

9. The vehicle according to claim 8, wherein said vibration damper comprises a tubular housing, in which said guide rod is disposed, wherein said weight is formed with a through-hole for said guide rod, and said spring arrangement includes two screw springs coupled to said weight and attached to a respective housing end face.
